(19) United States
(12) Patent Application Publication
(10) Pub. No.: US 2013/0164065 A1
(43) Pub. Date: Jun. 27, 2013

(54) IMAGE FORMING APPARATUS

(71) Applicant: CANON KABUSHIKI KAISHA, Tokyo (JP)

(72) Inventor: Kazuhiro Kosuga, Abiko-shi (JP)

(73) Assignee: CANON KABUSHIKI KAISHA, Tokyo (JP)

(21) Appl. No.: 13/714,138

(22) Filed: Dec. 13, 2012

(30) Foreign Application Priority Data
Dec. 21, 2011 (JP) 2011-280098

(51) Int. Cl. G03G 15/00

(52) U.S. Cl. CPC G03G 15/657
USPC 399/400

(57) ABSTRACT

An image forming apparatus includes a transfer unit, a fixing unit, a conveyance belt, a suction unit, and a control unit. The transfer unit transfers a toner image to a sheet. The fixing unit conveys the sheet and to fix the toner image transferred by the transfer unit on the sheet. The conveyance belt provided between the transfer unit and the fixing unit conveys the sheet. The suction unit suctions the sheet to the conveyance belt. The control unit controls to suction the sheet to the conveyance belt, and controls to stop suction or weaken a suction force in response to performing conveyance control for changing a conveyance speed of the fixing unit so that a loop amount of the sheet between the transfer unit and the fixing unit is maintained in a constant range after the leading edge of the sheet reaches the fixing unit.

### BACKGROUND OF THE INVENTION

1. Field of the Invention

The present invention relates to an image forming apparatus capable of forming an image on a sheet.

2. Description of the Related Art

In an electrophotographic image forming apparatus such as a copying machine, a laser beam printer, and a facsimile, a toner image is transferred to a sheet by a transfer unit, and the transferred toner image is fixed by a fixing unit. A belt conveyance unit configured to convey the sheet while suctioning the sheet to a conveyance belt is provided between the transfer unit and the fixing portion (see Japanese Patent Application Laid-Open No. 2010-198011). In the belt conveyance unit, the conveyance belt conveys the sheet with the sheet held by suction, and thereby the sheet is stably conveyed to the fixing unit with a conveyance property improved without damaging an unfixed toner image. When the sheet moves from the transfer unit to the fixing portion, a middle of the sheet is lowered and moves the ends of the sheet towards one another. This imparts a curved in the sheet that is a relatively wide open loop, where the loop allows adjusting the conveyance speed of the sheet without tugging on the sheet and scattering yet-to-be-fixed toner on the sheet.

A loop amount of the sheet may be determined based on a vertical position of a loop portion of the sheet. A sensor configured to detect a loop of the sheet is arranged between the transfer unit and the fixing portion. A loop amount of the sheet is maintained in a constant range by controlling a sheet conveyance speed of the fixing unit based on the detection of the sensor (hereinafter, referred to as loop control). The loop control is performed to deal with a change in the sheet conveyance speed from the fixing unit, which is caused by a change in an outer diameter of a roller of the fixing unit according to a temperature of the roller. For example, when the roller of the fixing unit is rotated and driven at a constant rotation number, thermal expansion increases the outer diameter of the roller when the roller is at high temperature, as compared with that at low temperature. The increase in the outer diameter or radius of the roller moves the peripheral of the roller further away from its center and increases a rotation peripheral speed of the roller exterior surface. Both the transfer unit and the fixing unit may nip the sheet at the same time. When the rotation peripheral speed is higher than a desired speed, the roller exterior surface of the fixing unit can pull the sheet from the transfer unit and cause transfer failure in the transfer unit. To deal with this issue, a loop is added to the sheet while the sheet moves from the transfer unit to the fixing portion and loop control is performed.

In the loop control, the sheet is conveyed while the sheet is suctioned downward from a flat position and held to the conveyance belt by a suction fan, and the conveyance speed in the fixing unit is controlled so that the loop amount of the sheet between the transfer unit and the fixing unit is maintained in a constant range. In the configuration for performing the loop control, image failure is caused in some cases by any uncontrolled motion of the sheet.

### SUMMARY OF THE INVENTION

When the sheet moves from the transfer unit to the fixing portion, the sheet is suctioned to the conveyance belt by the suction fan so that a middle of the sheet is lowered to form a loop in the sheet. If the conveyance speed of the fixing unit is increased in response to a rise in temperature due to the leading edge of the sheet reaching the fixing unit, the horizontal force on the sheet caused by increase in sheet conveyance speed tends to reduce the loop amount (tends to straighten out the sheet). However, the downward force of the suction fan on the sheet hinders reduction in the loop amount. There will be a period in the loop control during which the loop amount of the sheet is not decreased while the conveyance speed of the fixing unit is high. At some point, the horizontal force on the sheet from the fixing unit allows the sheet to finally overcomes a downward suction force on the sheet from the suction fan to separate the sheet from the conveyance belt. However, the suddenly lost of downward suction when the sheet is separated from the conveyance belt along with the horizontal force imparted into the sheet by the downstream fixing unit while the sheet is secured upstream by the transfer unit causes the sheet to unbend and rise up quickly such that the sheet is greatly uncontrolled. The uncontrolled motion of the sheet disadvantageously causes scattering of the toner of an unfixed image and an image blur in the transfer unit.

The present invention is directed to an image forming apparatus capable of sheet conveyance stabilized by a conveyance belt and of reduction in image failure during loop control.

According to an aspect of the present invention, an image forming apparatus includes a transfer unit configured to transfer a toner image to a sheet, a fixing unit configured to convey the sheet and to fix the toner image transferred by the transfer unit on the sheet, a conveyance belt provided between the transfer unit and the fixing unit and configured to convey the sheet, a suction unit configured to suction the sheet to the conveyance belt, and a control unit configured to control the suction unit so that the suction unit operates to suction the sheet to the conveyance belt in response to a leading edge of the conveyed sheet being located between the transfer unit and the fixing unit, and that the suction unit stops suction or weakens a suction force thereof in response to performing conveyance control for changing a conveyance speed of the fixing unit so that a loop amount of the sheet between the transfer unit and the fixing unit is maintained in a constant range after the leading edge of the sheet reaches the fixing unit.

An exemplary embodiment can achieve both reduction in image failure during loop control and a conveyance property of a sheet. Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is an overall schematic diagram of an image forming apparatus according to an exemplary embodiment.

FIG. 2 is a schematic diagram of a fixing device arranged in the image forming apparatus according to the exemplary embodiment.

FIG. 3 illustrates a configuration relating to sheet conveyance between an image transfer unit and an image fixing unit in the image forming apparatus according to the exemplary embodiment.

FIG. 4 illustrates the configuration relating to the sheet conveyance between the image transfer portion and the image fixing portion in the image forming apparatus according to the exemplary embodiment.

FIG. 5 is a plan view of a belt conveyance unit.

FIG. 6 is a flow chart of control relating to sheet conveyance.

FIG. 7 is a graph illustrating a conveyance speed relationship between the image transfer unit and the image fixing unit.

FIG. 8 is a block diagram of the image fixing unit and the belt conveyance unit in the image forming apparatus according to the exemplary embodiment.

FIG. 9A is a plan view illustrating a configuration of a modification of the belt conveyance unit.

FIG. 9B is the plan view illustrating the configuration of the modification of the belt conveyance unit.

FIG. 10A is a perspective view illustrating a configuration of the modification of the belt conveyance unit.

FIG. 10B is the perspective view illustrating the configuration of the modification of the belt conveyance unit.

### DESCRIPTION OF THE EMBODIMENTS

Various exemplary embodiments, features, and aspects of the invention will be described in detail below with reference to the drawings.

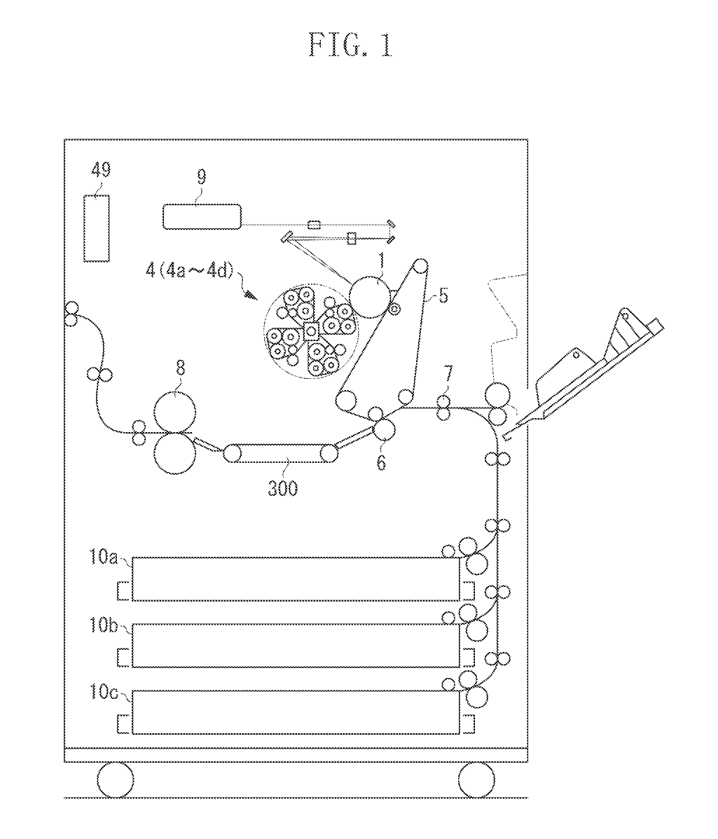

FIG. 1 illustrates a printer which is a specific example of a full color image forming apparatus according to an exemplary embodiment. The printer includes a drum 1, a rotary-type developing unit 4, and an intermediate transfer unit 6. The printer of the present exemplary embodiment includes formation of an image using colors of Y (yellow), M (magenta), C (cyan), and K (black) via developing devices 4a, 4b, 4c, and 4d. The printer also includes a laser output portion 9, a control device 49 as a control unit, and a belt conveyance unit 300. However, the present exemplary embodiment is not limited thereto.

The laser output portion 9 converts a laser beam into a light signal for an image station of each color. The laser beam converted into the light signal is reflected by a polygon mirror, and exposes a surface of each photoconductive drum 1 via a lens and a folding mirror.

A charging device, developing devices 4a, 4b, 4c, and 4d arranged in a developing rotary 4, and a cleaning device are arranged around the photosensitive drum 1. Each color development for an exposed image formed on the photosensitive drum 1 is performed by repeating a process for rotating the developing rotary 4 to accordingly switch the developing devices 4a to 4d, for a required color. A toner image is transferred from the photosensitive drum 1 to an intermediate transfer belt 5 to superimpose images for the required color on the intermediate transfer belt 5. Then, to transfer the toner image to a sheet (such as a plain paper sheet) which is a recording medium, the sheet is conveyed from a registration roller 7 toward an image transfer unit 6 as a transfer unit.

The sheet is fed out from a cassette 10a, 10b, or 10c to be conveyed. After the sheet is subjected to skewing correction by the registration roller 7, the sheet is conveyed toward the image transfer unit 6, which is a secondary transfer unit. In the image transfer unit 6, a secondary transfer outer roller presses against the intermediate transfer belt 5 to form a secondary transfer nip by utilizing a space (clearance) of images formed on the intermediate transfer belt 5. The sheet passes through the secondary transfer nip in synchronization with the image on the intermediate transfer belt 5 to receive a high voltage for secondary transfer, so that the toner image formed on the intermediate transfer belt 5 is transferred to the sheet by the passing. That is, the sheet is conveyed by the secondary transfer nip at a predetermined transfer speed K of the image transfer unit 6 while the toner image is transferred by the secondary transfer nip. Then, the secondary transfer outer roller is evacuated by utilizing the spacing (the clearance) of the images in a similar manner as the case of the pressure before a subsequent image reaches the secondary transfer unit. FIG. 1 illustrates a state where the secondary transfer outer roller presses against the intermediate transfer belt 5.

The sheet, now secondarily transferred by the image transfer unit 6, is conveyed from the image transfer unit 6 towards a fixing device 8. The fixing device 8 is a fixing unit configured to fix the toner image on the sheet. In the fixing device 8, the toner image is heated and fixed. Once the toner image is fixed, the fixing device 8 discharges the sheet downstream.

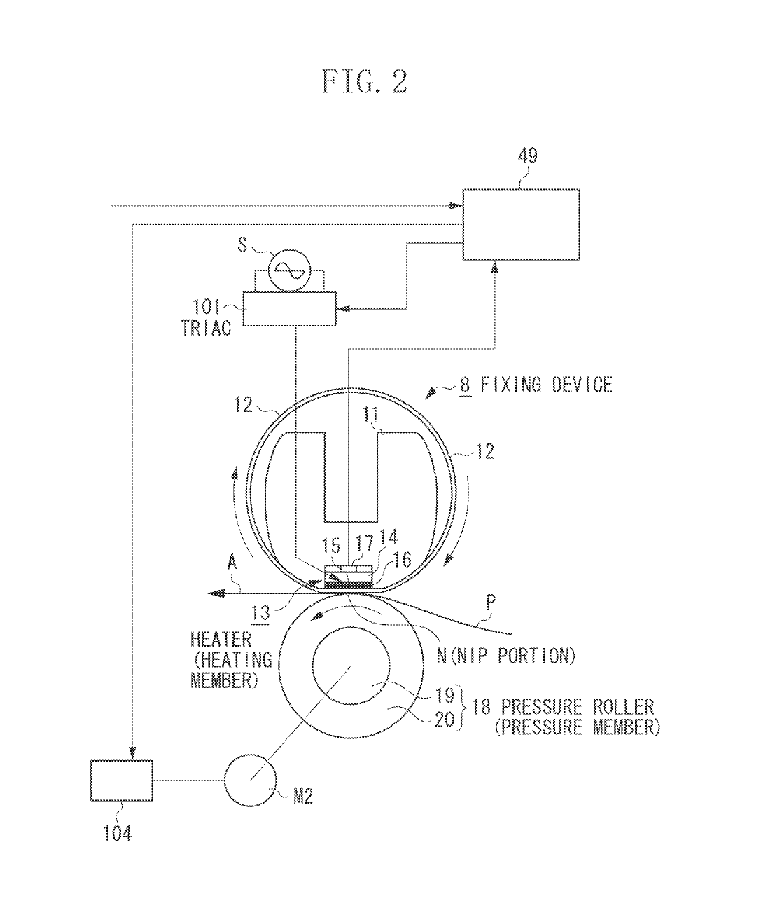

Next, a configuration of the fixing device 8 will be described with reference to FIG. 2. The fixing device 8 is a film heating type heating device using a pressure member driving method and a tensionless type. A landscape stay 11 made of a heat resistant resin is included in an inner surface guide member for an endless heat resistant film 12 (hereinafter, referred to as a film). The film 12 is externally fitted to the stay 11, which includes a heater 13 as a heating member.

The heater 13 is obtained by coating an electrical-resistance material (a heating element) 15 such as silver-palladium by screen printing or the like along the longitudinal on the approximately central portion of the surface of a substrate 14 made of alumina or the like which is a highly thermal conductive material, and by coating glass and a fluororesin or the like as a protection layer 16 thereon. The heater 13 additionally includes a thermistor 17, whose output resistance varies significantly with input temperature.

A film pressure roller (hereinafter, referred to as a pressure roller) 18 is a rotator which forms a nip portion (a fixing portion) N with the film 12 nipped between the pressure roller 18 and the heater 13, and drives the film 12. The nip portion N is a pressure nip. The pressure roller 18 includes a core shaft 19 made of as aluminum, iron, and stainless steel or the like, and a roller portion 20 including an elastic body externally fitted to the shaft 19. The elastic body is made of heat resistant rubber such as a silicon rubber or the like, and releases sheets easily.

The end portion of the core shaft 19 is driven by a motor M2 for driving the fixing device 8, and thereby the pressure roller 18 is rotated and driven in a counterclockwise direction indicated by the arrow. The pressure roller 18 is rotated and driven, and thereby the film 12 is rotated and driven in a clockwise direction indicated by the arrow while the inner surface of the film 12 closely slides on the surface of the heater 13.

When the pressure roller 18 is rotated and driven, a migration force is applied to the film 12 by a frictional force between the film 12 and the pressure roller 18 in the nip potion N, to rotate the film 12 at the approximately same speed as the rotational circumferential speed of the pressure roller 18. The film 12 is rotated and driven in a clockwise direction while the inner surface of the film 12 slides on the surface of the heater 13 (=the surface of the protection layer 16).

In a state where the film 12 is driven and the heating element layer 15 of the heater 13 is energized, the sheet P on which an unfixed toner image is born is introduced upward from the belt conveyance unit 300 and the image transfer unit 6 into the nip potion N (between the film 12 and the pressure roller 18) of the fixing device 8 which is the fixing unit, with a toner image carrying surface directed upward. Then, the sheet P passes through the nip potion N, with the film 12, in a direction indicated by a symbol A in FIG. 2. The thermal energy of the heater 13 contacting the inner surface of the film 12 in the nip potion N is applied to the sheet via the film 12. The toner image is thermally fixed by a pressure force in the nip potion N.

A voltage is applied (power is supplied) between both of the longitudinal ends of the heating element layer 15 of the heater 13, and thereby the heating element layer 15 generates heat to heat the substrate 14. The entire heater 13 includes a low thermal capacity that has an excellent temperature rise to rapidly increase the temperature of the substrate 14.

In the temperature control of the heater 13, analog-to-digital (A/D) conversion is performed based on the output resistance of the temperature sensing thermistor 17 provided on the heater 13. The output is taken from the thermistor 17 into a control device 49 as a control unit. The control device 49 may communicate with a Triode for Alternating Current (TRIAC) 101 that can conduct current in either direction when triggered or turned on. An AC voltage with which the heating element layer 15 of the heater 13 is energized by the triac 101 based on information from the thermistor 17 is applied by controlling heater energization power supply according to phase and wave number control and the like. An AC power supply S, illustrated in FIG. 2, supplies electric power to the heating element layer 15 as an electrical load. The temperature of a sheet feeding potion of the heater 13 is controlled to maintain a constant temperature during fixing by controlling energization so that the temperature of the heater 13 is increased when the detected temperature of the thermistor 17 is lower than a predetermined set temperature, or so that the temperature of the heater 13 is decreased when the detected temperature of the thermistor 17 is higher than the predetermined set temperature.

The energization to the heater 13 is turned off during standby while the image forming apparatus waits for a print command. The energization to the heater 13 is started after the print command by turning a main switch on.

The pressure roller 18 of the fixing device 8 is driven by the motor M2 illustrated in FIG. 2. A motor controller 104 performs drive control of the motor M2, and is controlled by the control device 49. That is, the pressure roller 18 is configured so that the driving speed (the rotation number) of the pressure roller 18 can be changed and controlled. A pulse motor is used for the motor M2 so that the rotation number of the pressure roller 18 can be accurately controlled. More specifically, the motor M2 is controlled so that the motor M2 can be rotated at two kinds of rotation numbers of high (Hi) and low (Lo), which has a rotation speed that is less than Hi. The motor M2 is driven and controlled so that the rotation number is set to either one of the Hi or Lo via the motor controller 104 by a signal from the control device 49.

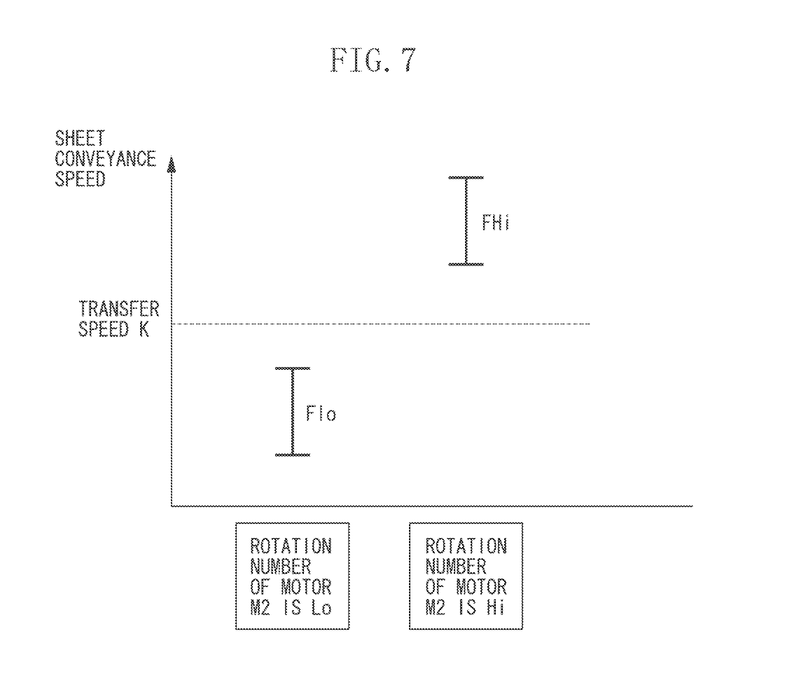

Herein, when the rotation number of the motor M2 is set to Hi and to Lo, a relationship between the sheet conveyance speed in the fixing device 8 (FIG. 1) and the sheet conveyance speed of the image transfer unit 6 will be described with reference to FIG. 7. When the rotation number of the motor M2 is controlled to Lo, an actual sheet conveyance speed FLo in the fixing (F) device 8 illustrated in FIG. 7 has a constant width. The actual sheet conveyance speed FLo has a width because the diameter of the pressure roller 18 configured to convey the sheet in the fixing device 8 changes according to the temperature of the pressure roller 18. That is, when a first sheet passes out of the fixing device 8 after the image forming apparatus is in a standby state for a while, the diameter of the pressure roller 18 is not so much thermally expanded, and thereby the sheet conveyance speed is low. While the sheet is continuously fed, the diameter of the pressure roller 18 gradually increases due to thermal expansion, and thereby the sheet conveyance speed becomes high. When the rotation number of the motor M2 is set to Lo, the sheet conveyance speed FLo of the fixing device 8 becomes lower than a transfer speed K, which corresponds to the sheet conveyance speed of the image transfer unit 6. That is, the rear end of the sheet P is moving faster downstream than the lead end of the sheet P, which may tend to increase the loop. When the rotation number of the motor M2 is controlled to Hi, an actual sheet conveyance speed FHi in the fixing device 8 has a constant width. When the rotation number of the motor M2 is set to Hi, the sheet conveyance speed FHi of the fixing device 8 becomes higher than the transfer speed K. That is, the rear end of the sheet P is moving slower downstream than the lead end of the sheet P, which may tend to decrease the loop. From FIG. 7, it is clear that the upper limit value of the sheet conveyance speed FLo of the fixing device 8 is lower than the transfer speed K, and the lower limit value of the sheet conveyance speed FHi of the fixing device 8 is higher than the transfer speed K. Thus, the sheet loop will tend to change.

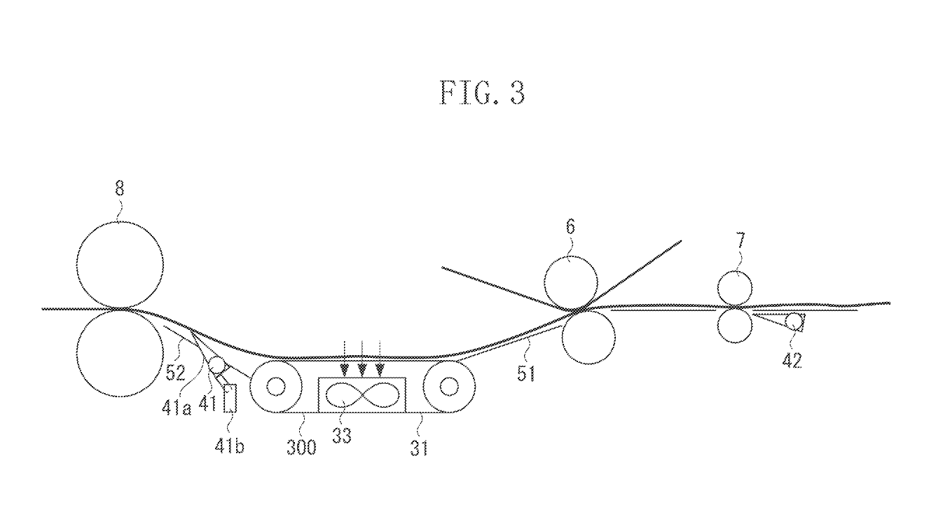

Next, a configuration and control relevant to sheet conveyance in a conveyance section between the circumference of the image transfer unit 6 and the fixing device 8 will be described with reference to FIGS. 3 to 7, 9A and 9B.

As illustrated in FIG. 3 (and FIG. 1), the registration roller (a pre-transfer conveyance roller) 7 is arranged upstream of the image transfer unit 6 in a conveyance direction to temporarily stop the sheet and to regulate the leading edge thereof to correct the skew of the sheet. After the skew of the sheet is corrected by the registration roller 7, the timing of the rotation start of the registration roller 7 is adjusted so that the leading edge of the sheet coincides with the position of the toner image formed on the intermediate transfer belt 5. Thus, the conveyance of the sheet is started by the rotation restart of the registration roller 7, and thereby the toner image is transferred to the sheet in the image transfer unit 6.

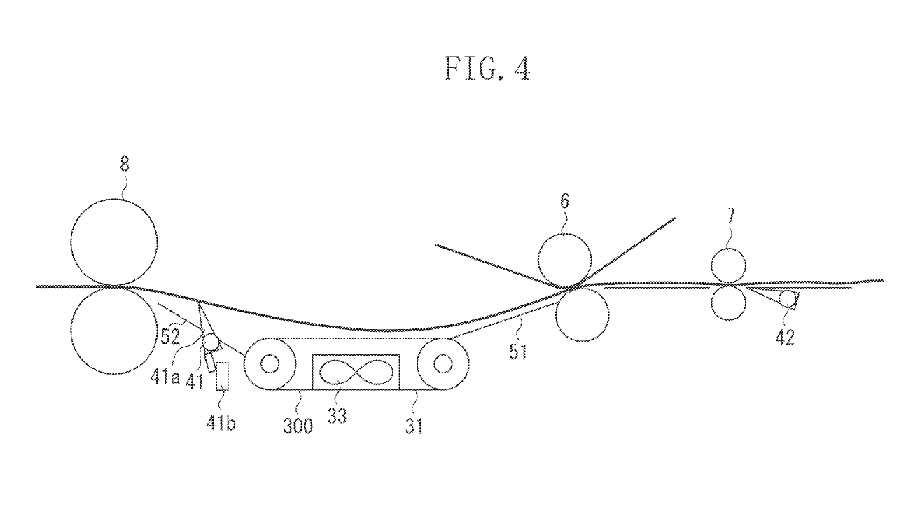

The belt conveyance unit 300 is provided on the downstream side in the sheet conveyance direction from the image transfer unit 6. As illustrated in FIGS. 3 and 4, a suction fan (a suction unit) 33 is provided inside the endless conveyance belt 31 in the belt conveyance unit 300.

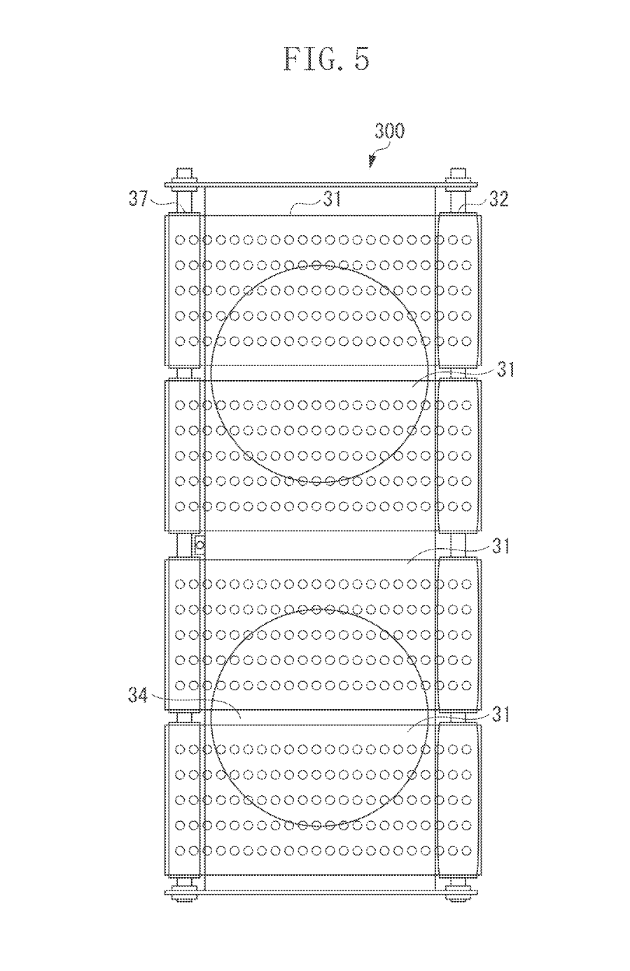

As illustrated in FIG. 5, the belt conveyance unit 300 includes four endless conveyance belts 31 having a large number of air suction holes formed therein, a driving roller 32 configured to rotate and drive the conveyance belts 31, and a driven roller 37. A negative pressure of air is generated by rotating and driving the suction fan 33 (shown in FIG. 5 as two large circles), and thereby the air is suctioned from openings 34 (see FIG. 5) formed between the suction fan 33 and the conveyance belt 31, and a large number of air suction holes formed on the conveyance belt 31. The sheet is suctioned to the conveyance belt 31 by air suction from the air suction holes, and thereby the sheet is held to contact the upper surface of the conveyance belt 31. The sheet suctioned and held to contact the conveyance belt 31 is conveyed in a direction indicated by the symbol A in FIG. 2, but toward the fixing device 8 by the rotation of the conveyance belt 31.

FIG. 3 illustrates a configuration relating to sheet conveyance from the image transfer unit 6 along the belt conveyance unit 300 to the image fixing unit 8 in the image forming apparatus with the suction fan 33 turned on (shown by the three downward arrows) to draw the sheet down onto the conveyance belt 31. FIG. 4 illustrates the configuration of FIG. 3, but with the suction fan 33 turned off (shown by the lack of downward arrows). With the suction fan 33 turned off, the sheet nipped between the image transfer unit 6 and the image fixing unit 8 will tend to rise upward from the conveyance belt 31 to reduce an amount of the loop in the sheet.

Returning to FIG. 3, a post-transfer conveyance guide 51 is inclined downward from the image transfer unit 6 to the belt conveyance unit 300 in the sheet conveyance direction. The downward incline to the belt conveyance unit 300 allows the sheet to be bent to impart a loop into the sheet. From the downstream end of the belt conveyance unit 300, a pre-fixing conveyance guide 52 is inclined upward toward the fixing device 8 in the conveyance direction. The upward incline from the belt conveyance unit 300 allows an additional bend to be imparted into the sheet to complete the sheet loop.

The printer also includes a registration sensor 42 provided on the upstream of the registration roller 7 as illustrated in FIG. 3 and a loop sensor 41 provide just upstream of the fixing device 8. The sensor 42 is used as a trigger to rotate the registration roller 7 and to stop the registration roller 7. The sensor 42 also is used to start the rotation of the suction fan 33 and includes a sensor lever and a photo interrupter to monitor the sensor lever. The loop sensor 41 is a detection unit arranged between the belt conveyance unit 300 and the fixing device 8 to detect a loop amount of the sheet. To detect a loop amount of the sheet, the loop sensor 41 generates a signal according to a vertical position of a loop portion of the sheet relative to the pre-fixing conveyance guide 52 between the image transfer unit 6 and the fixing device 8. For example, the loop in FIG. 3 is closer to the pre-fixing conveyance guide 52 due to the suction fan 33 being on and the loop in FIG. 4 is further away vertically from the pre-fixing conveyance guide 52 due to the suction fan 33 being off. Where the upstream registration sensor 42 is used as a trigger to start the suction fan 33, the downstream loop sensor 41 is used as a trigger to stop the suction fan 33. The loop sensor 41 of the present exemplary embodiment includes a sensor lever 41a pressed and moved by the sheet passing over the sensor lever 41a, and a photo interrupter 41b configured to monitor the sensor lever 41a and generate a signal according to a position of the sensor lever 41a.

The sheet P conveyed by the conveyance belt 31 is fed into the fixing device 8 while being guided along the pre-fixing conveyance guide 52. After the toner image formed on the sheet is fixed as described above in the fixing device 8, the sheet is conveyed to the downstream side by the fixing device 8.

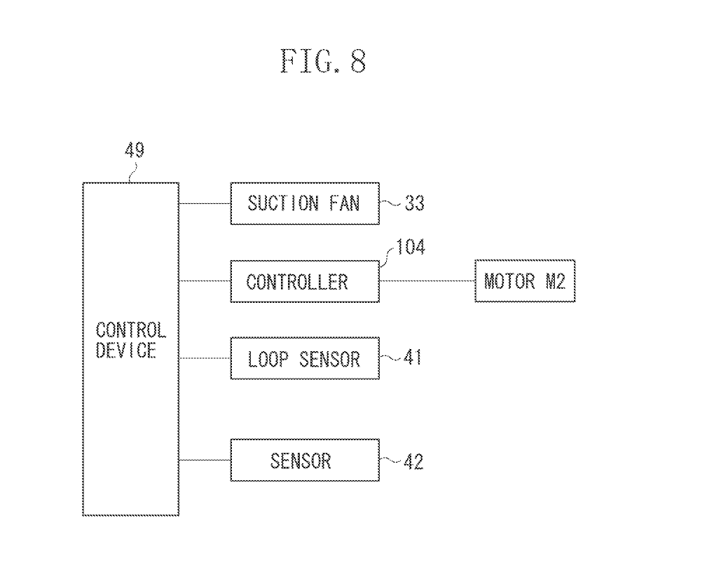

FIG. 8 is a control block diagram relating to sheet conveyance control of the belt conveyance unit 300 and the fixing device 8. A detection signal from the registration sensor 42 provided on the upstream of the registration roller 7 is transmitted to the control device 49. A detection signal from the loop sensor 41 is also transmitted to the control device 49. The control device 49, which may be a central processing unit (CPU), controls the operation of the suction fan 33, for example, on based on the upstream registration sensor 42 signal and off based on the downstream loop sensor 41 signal. In addition, the control device 49 controls the operation of the motor M2 to rotate and drive the fixing device 8 via the motor controller 104. As for the rotation control of the motor M2, as generally described above, the control device 49 switches the rotation number of the motor M2 between Hi and Lo depending, for example, on the upstream registration sensor 42 signal and the downstream loop sensor 41 signal.

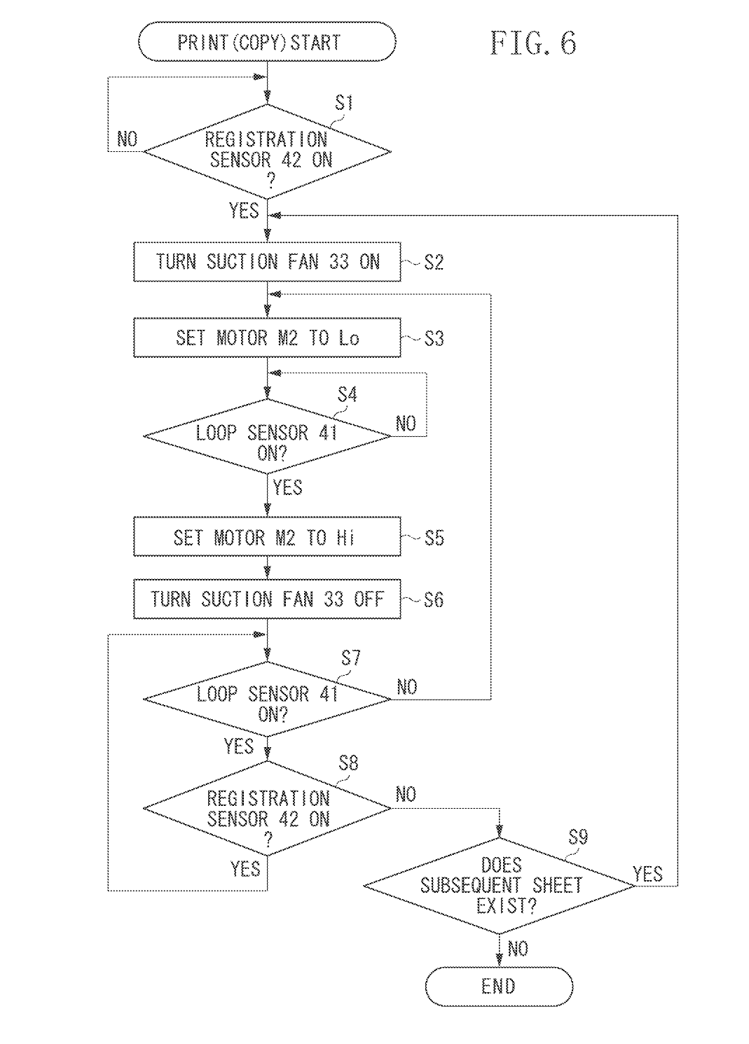

Next, the detailed description of the sheet conveyance control in the belt conveyance unit 300 and the fixing device 8 will be described with reference to FIG. 6, which is a control flow chart. To begin, a sheet to be conveyed is fed out from a cassette 10a, 10b, or 10c (FIG. 1) towards the registration roller 7 after print start. In step S1, when the leading edge of the sheet reaches the detection place of the sensor 42 after the print start, and when the sensor lever of the sensor 42 is pressed down by the sheet, an ON signal is sent to the control device 49 from the photo interrupter of the sensor 42. The ON signal indicates that the sheet has reached a point just before the image transfer unit 6 and that a time is nearing to turn on the fan 33 to generate a suction. In step S2, the control device 49 controls the suction fan 33 to start the rotation of the fan 33 after a previously set definite period of time lapses after the sensor 42 generates the ON signal. The previously set definite period of time herein is set so that the rotation of the suction fan 33 is started after the trailing edge of a preceding sheet passes through the image transfer unit 6 and before the leading edge of the sheet reaches the belt conveyance unit 300.

In step S3, the control device 49 controls the motor M2 so that the rotation number of the motor M2 is set to Lo after the sensor 42 generates the ON signal. Setting the rotation number of the motor M2 to Lo will cause the rotation speed of the fixing device 8 to be Lo.

As the sheet receives the toner image from the image transfer unit 6, the sheet will move forward and be drawn onto the conveyance belt 31 due to the suction from the suction fan 33. The loop sensor 41 waits in step S4 to receive the sheet from the conveyance belt 31. If the control device 49 determines that the detection signal transmitted from the loop sensor 41 is OFF (No in step S4), the control flow returns to step S4. If the control device 49 determines that the detection signal transmitted from the loop sensor 41 changes to ON (YES in step S4), then the change to ON of the detection signal transmitted from the loop sensor 41 corresponds to the reach of the leading edge of the sheet conveyed by the belt conveyance unit 300 to the detection place of the loop sensor 41. In other words, this is an indication that the sheet has reached the position of the loop sensor 41 and that a time is nearing to transition a rotational speed of the fixing device 8 from Lo to Hi. In step S5, the control device 49 sets the rotation number of the motor M2 to Hi. In the present exemplary embodiment, in step S5, after the detection signal changes to the ON signal and when the time elapses in which it is predicted that the leading edge of the sheet is nipped by the fixing device 8, the control device 49 sets the rotation number of the motor M2 to Hi. In addition, in step S6, the control device 49 stops the rotation of the suction fan 33 in response to the signal from the loop sensor 41. Stopping the rotation of the suction fan 33 will reduce the downward suction force on the sheet. Even if the rotation of the suction fan 33 is stopped, the rotation of the conveyance belt 31 is continued. This has a benefit of moving the sheet forward without disruption to the extent the sheet remains drawn to the conveyance belt 31 and maintains the conveyance belt 31 in a ready state to receive subsequent sheets.

In steps S1 to S7, the sheet is conveyed through the registration roller 7 and the image transfer unit 6, down along the post-transfer conveyance guide 51, along the belt conveyance unit 300, and up the pre-fixing conveyance guide 52, and enters the nip N (FIG. 2) of the fixing device 8. Since the suction fan 33 is rotated (operated—see FIG. 3), and since the sheet is conveyed while being suctioned to and held by the conveyance belt 31 at this time, the sheet has a loop shape projecting downward to track the surface shapes of the post-transfer conveyance guide 51 and pre-fixing conveyance guide 52 and the belt conveyance unit 300 as illustrated in FIG. 3. In other words, the state (the shape) of the sheet is one where the lower position of belt conveyance unit 300 relative to the nips of the image transfer unit 6 and the fixing device 8 along with suction from the suction fan 33 draws a middle portion of a sheet downward and forces the sheet from a straight form to one with two bended curves so that the sheet deviates from flat into one shaped more or less like a loop.

After the rotation of the suction fan 33 is stopped in step S6, the sheet will continue to pass over the loop sensor 41. During this time, the vertical position of loop of the sheet may change from a first position adjacent to the pre-fixing conveyance guide 52 that push down on the sensor lever 41a (FIG. 3) to a second position that is more remote from the pre-fixing conveyance guide 52 than the first position such that the sensor lever 41a rises (FIG. 4). At some point after the rotation of the suction fan 33 is stopped in step S6, such as when the vertical position of loop of the sheet reaches a predetermined height from the pre-fixing conveyance guide 52, the detection signal transmitted from the loop sensor 41 will turn to an OFF signal. At step S7, the control device 49 determines whether the detection signal transmitted from the loop sensor 41 is an OFF signal or an ON signal.

When the control device 49 determines at step S7 that the detection signal transmitted from the loop sensor 41 turns to an OFF signal after the rotation of the suction fan 33 is stopped in step S6 (NO in step S7), the process proceeds to step S3 to switch the rotation number of the motor M2 from Hi in step S5 to Lo. That is to say, while the horizontal pull on the sheet overcomes the now decreasing downward suction force, the sheet rises from the belt conveyance unit 300 and reaches a vertical position to where the loop sensor 41 turns off in step S7. The method of FIG. 6 then returns to step S3 to lessen the speed at which the fixing device 8 horizontal pulls on the sheet to slow that rise. Thus, instead of the sheet uncontrollably rising up and unbending quickly, the loop control from the control device 49 controls the upward movement and unbending of the sheet. Here, the controlled motion of the sheet beneficially reduces a likelihood of scattering the unfixed image and, thus, reduces a likelihood image blur.

After switching the rotation number of the motor M2 in step S3 from Hi to Lo, the control device 49 determines at step S4 whether the loop sensor 41 is an ON signal at step S4. So long as the control device 49 determines at step S4 that the loop sensor 41 has not turned to an ON signal, the speed of the motor M2 remains at Lo and any further upward movement and unbending of the sheet remains under control. If the control device 49 determines at step S4 that the loop sensor 41 has turned to an ON signal, then the sheet has move from a second position above the sensor lever 41a to a first position that push down on the sensor lever 41a, such as due to pushing on the sheet from the transfer unit 6. To control downward movement and bending of the sheet, the control device 49 sets the motor M2 from Lo to Hi at step S5 to increase the speed at which the fixing device 8 draws the sheet through it. In an example, before step S6 may be a determining step where the control device 49 determines whether the suction fan 33 is on or off and proceeds according. From step S6, the process proceeds to step S7 where the control device 49 determines whether the loop sensor 41 is an ON signal.

As noted above, the control device 49 performs loop control for switching the rotation number of the motor M2 between Hi and Lo so that the loop amount of the sheet is adjusted based on the signal of the loop sensor 41 by repeating the subsequent steps S3 to S7. When the detection signal from the loop sensor 41 is in an OFF state, that is, in the case where the vertical position of the loop portion of the sheet is high (in the case where the loop amount is small), the control device 49 controls the motor M2 so that the rotation number of the motor M2 is set to Lo (a fixing conveyance speed Lo). On the other hand, the control device 49 controls motor M2 so that the rotation number of the motor M2 is set to Hi (a fixing conveyance speed Hi) when the detection signal from the loop sensor 41 is in an ON state (when the loop amount is large).

Herein, the behavior of the sheet will be described when loop control is performed for switching the rotation number of the motor M2 between Hi and Lo so that the loop amount of the sheet is maintained in a constant range.

Since the conveyance speed of the fixing device 8 becomes higher than the transfer speed K of the image transfer unit 6 in a state where the rotation number of the motor M2 is Hi (the sheet conveyance speed FHi of the fixing device 8), the loop amount of the sheet is gradually decreased. In this state, the suction fan 33 is stopped and does not hinder the reduction of the loop amount. That is, the sheet is conveyed by the fixing device 8 having a conveyance speed higher than the transfer speed K, and thereby the loop amount is decreased. Thus, since the rotation of the suction fan 33 is stopped and suction is not performed, the suction of the suction fan 33 does not resist the deformation of the loop portion of the sheet projecting downward to be an approximately linear shape between the image transfer unit 6 and the fixing device 8. In other words, without the downward suction provided by the suction fan 33, the sheet residing between the image transfer unit 6 and the fixing device 8 will tend to move upward away from a loop shape and towards a more linear, flat shape, such that the loop amount decreases.

After step S6 when the loop amount decreases to a point where the detection signal transmitted from the loop sensor 41 turns from an ON signal to an OFF signal in step S7, the control device 49 switches the rotation number of the motor M2 from its Hi state in step S5 to Lo in step S3. Therefore, the sheet conveyance speed of the fixing device 8 becomes lower than the transfer speed K. When the control device 49 switches the rotation number of the motor M2 to Lo at step S3, and when the sheet conveyance speed FLo of the fixing device 8 becomes lower than the transfer speed K of the image transfer unit 6, the loop amount of the sheet is increased, this time due to pushing on the sheet from the image transfer unit 6 rather than suction from the suction fan 33 drawing the sheet downward. As illustrated in FIG. 3, the shape of the sheet approaches the shape (state) projecting downward.

When the control device 49 determines at step S7 that the detection signal transmitted from the loop sensor 41 turns to an ON signal (YES in step S7), the process proceeds to step S8. At step S8, the control device 49 determines whether the trailing edge of the sheet has passed beyond the detection place of the registration sensor 42. That is to say, while the trailing end of the sheet having the toner image being fixed in the fixing device 8 continues to press down on the registration sensor 42, the control device 49 determines at step S8 that the signal from the registration sensor 42 is ON (YES in step S8). Until the signal from the registration sensor 42 becomes OFF (NO in step S8), that is, until the trailing edge of the sheet passes through the detection place of the sensor 42, the switch of the rotation number of the motor M2 between Lo and Hi is repeated in steps S3 to S7. Here, the controlled upward and downward motion of the sheet and controlled change in sheet loop beneficially reduces a likelihood of scattering the unfixed image and, thus, reduces a likelihood image blur.

After the trailing edge of the sheet passes the sensor 42 (NO in step S8), the control device 49 determines whether a subsequent sheet to be fed exists in step S9. When the subsequent sheet exists (YES in step S9), after a definite period of time lapses (after the trailing edge of the sheet ahead of the subsequent sheet passes through the image transfer unit 6), the control device 49 rotates the suction fan 33 and sets the rotation number of the motor M2 to Lo. Therefore, when the sheet is continuously conveyed, the subsequent sheet can be prepared. When the subsequent sheet does not exist (NO instep S9), the job ends. Here, the rotation of the conveyance belt 31 may be discontinued.

In the exemplary embodiment, the change of the suction force of the sheet in the belt conveyance unit 300 is controlled by rotating and stopping the suction fan 33. However, instead of rotating and stopping the suction fan 33, the rotation number of the suction fan 33 may be controlled to be less than that when the leading edge of the sheet is directed to the fixing device 8 to a point where the suction force of the sheet to the conveyance belt is weakened to an extent that the loop shape is unaffected by the suction force as the loop amount is decreased. The sensor including the sensor lever 41a and the photo interrupter 41b is exemplified as the loop sensor 41. However, an optical ranging sensor configured to detect the vertical position of the sheet may be used. The configuration of the fixing device 8 using the film 12 is exemplified. However, the fixing device 8 may be configured to convey a sheet with the sheet nipped between a pair of rollers. The fixing device 8 may be configured to convey a sheet with the sheet nipped between a belt and a roller.

The exemplary embodiment exhibits the following effects. The sheet is conveyed toward the fixing device 8 in a state where the suction fan 33 is operated so that the sheet is suctioned to the conveyance belt 31 when the leading edge of the sheet is located on the upstream from the fixing device 8. Therefore, the sheet can be stably conveyed between the image transfer unit 6 and the fixing device 8. In the present exemplary embodiment, since the suction fan 33 is operated so that the sheet is suctioned to the conveyance belt 31 until the leading edge of the sheet reaches the nip portion N of the fixing device 8, the leading edge of the sheet can be certainly led to the nip portion N of the fixing device 8 by the belt conveyance unit 300.

After the leading edge of the sheet is nipped by the nip portion N of the fixing device 8, the suction fan 33 is controlled so that the suction fan 33 loses the suction force suctioning the sheet to the conveyance belt 31 (stops the suction) or weakens the suction force (decreases the amount of suction of air). The uncontrolled motion of the sheet caused by the suction of the sheet to the conveyance belt 31, when the loop amount of the sheet formed between the image transfer unit 6 and the fixing device 8 is controlled based on the detection result of the loop sensor 41, is decreased by stopping the suction fan 33. The uncontrolled motion of the sheet caused by the suction of the sheet to the conveyance belt 31, when the loop amount of the sheet formed between the image transfer unit 6 and the fixing device 8 is controlled based on the detection result of the loop sensor 41, is decreased also by weakening the suction force of the suction fan 33. The uncontrolled motion of the sheet is decreased, and thereby the scattering of an unfixed image and the generation of image blur in the image transfer unit 6 are suppressed.

The suction fan 33 may be continuously rotated; a mechanism configured to block the flow of air via a shutter may be provided between the suction fan 33 and the conveyance belt 31; and the suction force to the conveyance belt 31 may be lost or weakened by controlling the opening and closing of the shutter.

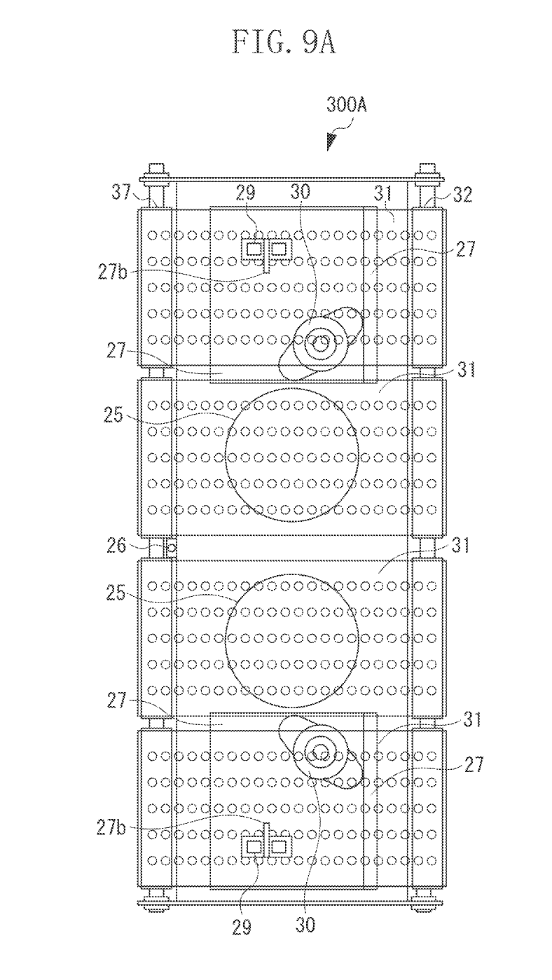

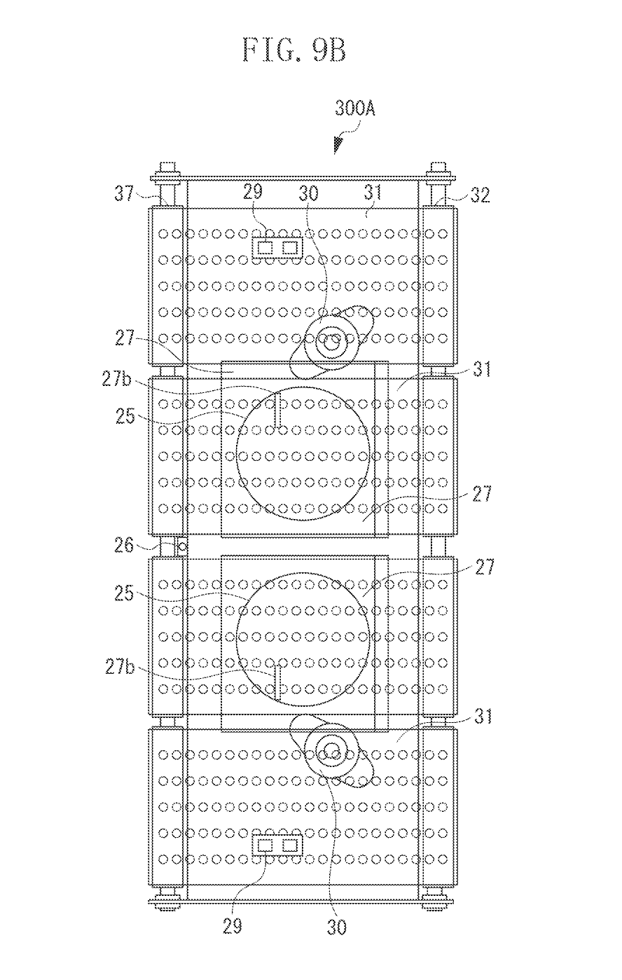

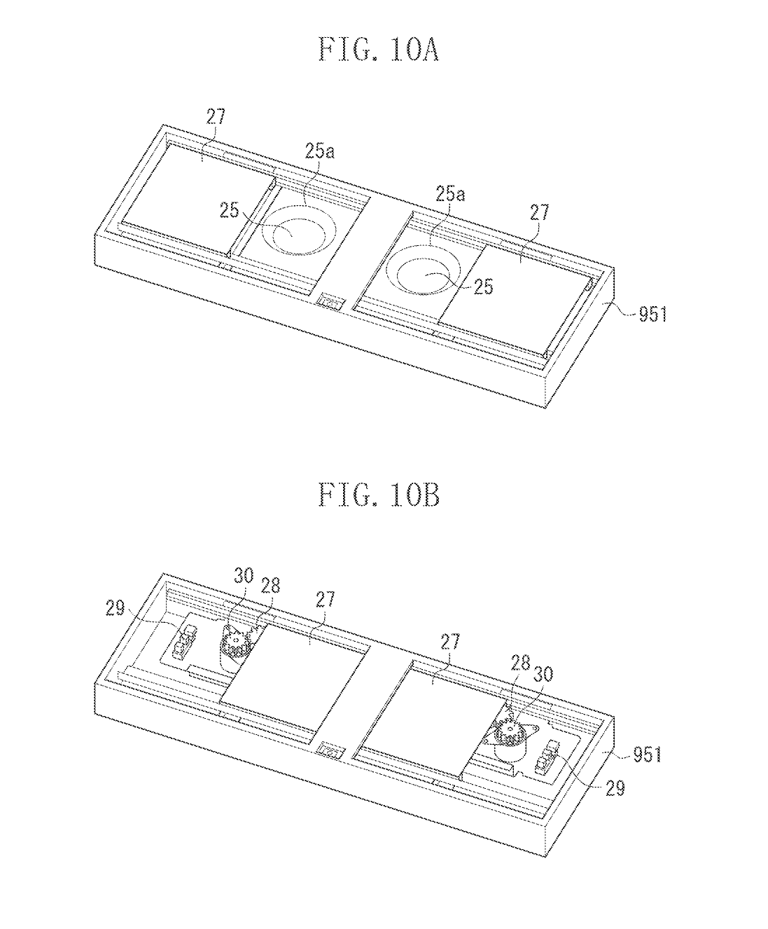

Hereinafter, a modification will be described using the shutter to switch the suction force suctioning the sheet to the conveyance belt 31. FIGS. 9A and 9B are plan views each illustrating a configuration of a belt conveyance unit 300A according to the present modification. FIGS. 10A and 10B are perspective views of the belt conveyance unit 300A in which drawing of the conveyance belt 31 is omitted in the present modification.

A frame 951 including a suction fan 25 is provided inside the conveyance belt 31. A pair of suction openings 25a is formed in the upper surface of the frame 951. A pair of shutters 27 is slidably held by the frame 951 between the conveyance belt 31 and the suction fan 25. The shutters 27 are slidably held by the frame 951 between a position at which a suction opening 25a is opened (see FIGS. 9A and 10A) and a position at which the suction opening 25a is closed (see FIGS. 9B and 10B).

The shutters 27 included in a suction unit with the suction fan 25 and the frame 951 are slid, and thereby the suction state of the sheet to the conveyance belt 31 can be changed in the belt conveyance unit 300A. Hereinafter, the position of the shutter 27 (see FIGS. 9A and 10A) when the suction opening 25a is opened is referred to as an open position, and the position of the shutter 27 (see FIGS. 9B and 10B) when the suction opening 25a is closed is referred to as a close position. When the shutter 27 is at the open position illustrated in FIGS. 9A and 10A, the sheet is suctioned to the conveyance belt 31. When the shutter 27 is at the close position illustrated in FIGS. 9B and 10B, the sheet is not suctioned to the conveyance belt 31.

A rack gear is provided in each of the shutters 27. The shutter 27 is slid in the width direction of the sheet by transmitting a drive force from a shutter drive motor 30 to the shutter 27 via a pinion gear 28 engaged with the rack gear, and thereby the suction opening 25a of the suction fan 25 is opened and closed.

A lever 27b is provided on each of the shutters 27. The shutter 27 is moved to the open position illustrated in FIGS. 9A and 10A as follows. More specifically, when the shutter drive motor 30 is driven, and when the lever 27b blocks the optical axis of a shutter detection sensor 29 to change the signal from the shutter detection sensor 29 to ON from OFF, the shutter drive motor 30 is stopped. Conversely, when the shutter 27 is moved towards the close position as illustrated in FIGS. 9B and 10B, the shutter drive motor 30 is rotated by a predetermined number of pulses.

In the configuration, the control device 49 controls the shutter drive motor 30 according to the signal from the shutter detection sensor 29 to change the position of the shutter 27, and thereby the suction force is changed. Herein, controlling operation according to the present modification is different from that in the flow chart of FIG. 6 in that “turn suction fan 33 on” (step S2) is replaced by “slide shutter 27 to open position”. Also, controlling operation according to the present modification is different from that in the flow chart of FIG. 6 in that “turn suction fan 33 off” (step S6) is replaced by “slide shutter 27 to close position”. That is, when the loop control is performed, the suction force is lost by using the shutter 27. Since the other control steps is the same as those described in FIG. 6, the control steps are not repeated herein to avoid the redundant descriptions.

In the present modification, the force suctioning the sheet to the conveyance belt can be changed with better responsiveness as compared with a configuration controlling the rotation number of the suction fan. The configuration is described in which, when the loop control is performed, the shutter 27 almost completely blocks (covers) the suction opening 25a at the close position. However, when the loop control is performed, for example, the shutter 27 may almost cover the opening 25a without completely covering the opening 25a so that the suction force to the conveyance belt 31 is weakened to an extent that the reduction in the loop amount is unaffected.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-280098 filed Dec. 21, 2011, which is hereby incorporated by reference herein in its entirety.

What is claimed is:

1. An image forming apparatus comprising:
a transfer unit configured to transfer a toner image to a sheet;
a fixing unit configured to convey the sheet and to fix the toner image transferred by the transfer unit on the sheet;
a conveyance belt provided between the transfer unit and the fixing unit and configured to convey the sheet;
a suction unit configured to suction the sheet to the conveyance belt; and
a control unit configured to control the suction unit so that the suction unit operates to suction the sheet to the conveyance belt in response to a leading edge of the conveyed sheet being located between the transfer unit and the fixing unit, and that the suction unit stops suction or weakens a suction force thereof in response to performing conveyance control for changing a conveyance speed of the fixing unit so that a loop amount of the sheet between the transfer unit and the fixing unit is maintained in a constant range after the leading edge of the sheet reaches the fixing unit.

2. The image forming apparatus according to claim 1, further comprising a detection unit configured to detect the sheet between the transfer unit and the fixing unit,
wherein the control unit changes the conveyance speed of the fixing unit so that the loop amount of the sheet, between the transfer unit and the fixing unit, is adjusted based on a detection signal from the detection unit.

3. The image forming apparatus according to claim 2, wherein the control unit determines whether the leading edge of the sheet conveyed by the conveyance belt reaches the fixing unit based on the detection signal from the detection unit.

4. The image forming apparatus according to claim 1, wherein the suction unit includes a fan, and
wherein the control unit stops rotation of the fan to stop suction, or changes a rotation number of the fan to weaken the suction force of the suction unit.

5. The image forming apparatus according to claim 1, wherein the suction unit includes a fan and a shutter configured to open and close between the fan and the conveyance belt, and wherein the control unit closes the shutter to stop the suction of the suction unit or changes an opening amount of the shutter to weaken the suction force of the suction unit.

6. The image forming apparatus according to claim 1, wherein the control unit operates the suction unit so that the sheet is suctioned to the conveyance belt until the leading edge of the conveyed sheet reaches the fixing unit.

7. The image forming apparatus according to claim 1, wherein, in response to the leading edge of the conveyed sheet being located between the transfer unit and the fixing unit, the control unit controls to rotate the conveyance belt, and in response to the suction unit stopping suction or weakening the suction force thereof, the control unit continues to rotate the conveyance belt.

8. An image forming apparatus comprising:
a transfer nip configured to convey a sheet and to transfer a toner image to the sheet;
a fixing unit configured to convey the sheet and to fix the toner image on the sheet;
a conveyance belt provided between the transfer nip and the fixing nip and configured to convey the sheet;
a suction unit configured to suction the sheet to the conveyance belt;
a lever provided between the transfer nip and the fixing nip, the lever being movable by being pressed by the conveyed sheet;
a photo interrupter configured to generate a signal according to a position of the lever; and
a control unit configured to change a conveyance speed of the fixing nip according to the signal generated from the photo interrupter while the sheet is nipped by both of the transfer nip and the fixing nip,
wherein the control unit controls the suction unit so that, while the sheet is nipped by both of the transfer nip and the fixing nip, the suction unit stops suction or the suction unit has a suction force smaller than that of the suction unit in response to a leading edge of the sheet being located between the transfer nip and the fixing nip.

9. The image forming apparatus according to claim 8, wherein the control unit changes the conveyance speed of the fixing nip so that a loop amount of the sheet between the transfer nip and the fixing nip is adjusted based on a detection signal from the photo interrupter.

10. The image forming apparatus according to claim 8, wherein the control unit determines whether the leading edge of the sheet conveyed by the conveyance belt reaches the fixing unit based on a detection signal from the photo interrupter.

11. The image forming apparatus according to claim 8, wherein the suction unit includes a fan, and
wherein the control unit stops rotation of the fan to stop suction, or changes a rotation number of the fan to weaken the suction force of the suction unit.

12. The image forming apparatus according to claim 8, wherein the suction unit includes a fan and a shutter configured to open and close between the fan and the conveyance belt, and
wherein the control unit closes the shutter to stop the suction of the suction unit or changes an opening amount of the shutter to weaken the suction force of the suction unit.

13. The image forming apparatus according to claim 8, wherein the control unit operates the suction unit so that the sheet is suctioned to the conveyance belt until the leading edge of the conveyed sheet reaches the fixing nip.

14. The image forming apparatus according to claim 8, wherein, in response to the leading edge of the conveyed sheet being located between the transfer unit and the fixing unit, the control unit controls to rotate the conveyance belt, and in response to the suction unit stopping the suction or weakening the suction force thereof, the control unit continues to rotate the conveyance belt.
